(19) United States
(12) Patent Application Publication
(10) Pub. No.: US 2026/0192594 A1
(43) Pub. Date: Jul. 9, 2026

(54) VIEWFINDER TOOL FOR ARTISTS

(71) Applicant: Stephen J. Puttrich, Holland, MI (US)

(72) Inventor: Stephen J. Puttrich, Holland, MI (US)

(21) Appl. No.: 19/439,052

(22) Filed: Jan. 2, 2026

Related U.S. Application Data
(60) Provisional application No. 63/742,615, filed on Jan. 7, 2025.

(51) Int. Cl. B44D 3/00; B43L 13/16

(52) U.S. Cl. CPC B44D 3/00; B43L 13/16

(57) ABSTRACT

An artist's viewfinder device including a plurality of nested and foldable frame windows. Each of the plurality of nested and foldable frame windows is foldable to open a corresponding viewfinder opening for framing a subject to draw or paint. Each of the plurality of nested and foldable frame windows corresponds to a commonly sold canvas size. Each of the plurality of nested and foldable frame windows includes a plurality of ratio indicators each corresponding to one of a plurality of corresponding painting substrate sizes for the viewfinder opening. Each of the plurality of nested and foldable frame windows includes a plurality of tick marks at golden ratio positions. The method of use includes folding one of the nested frame windows to open a viewfinder opening corresponding to a size of a substrate to be painted or drawn and through which a subject of an artwork is to be viewed.

### CROSS REFERENCE TO RELATED APPLICATION

This application claims the benefit of U.S. Provisional Application, Ser. No. 63/742,615, filed on 7 Jan. 2025. The co-pending provisional application is hereby incorporated by reference herein in its entirety and is made a part hereof, including but not limited to those portions which specifically appear hereinafter.

### FIELD OF THE INVENTION

This invention relates generally to a device and method for assisting artists to frame a subject and, more particularly, to a customizable viewfinder for matching a view of a subject and a painting/drawing surface, such as a canvas, paper, board, or other substrate.

### BACKGROUND OF THE INVENTION

Composition is arranging elements within artwork. A strong composition leads the viewer's eye through the piece, directing their attention to areas of significance. Good composition guides the narrative and establishes balance, harmony, and contrast. A well-composed painting captures attention, creates emotional impact, and leaves a lasting impression. There is a need for tools to assist artists, particularly beginners, with composition.

### SUMMARY OF THE INVENTION

A general object of the invention is to provide a device and method for framing a subject to paint or draw. The invention provides a customizable viewfinder for matching a view of a subject and a painting/drawing surface, such as a canvas, paper, board, or other substrate.

Embodiments of this invention provide a viewfinder device including a plurality of nested and foldable frame windows. Each of the plurality of nested and foldable frame windows is moveable/foldable to open a corresponding viewfinder opening that is used to frame a subject to paint or draw.

Desirably, each of the plurality of nested and foldable frame windows corresponds to a predetermined/common artwork substrate (e.g., canvas or paper) size. In embodiments of this invention, each of the plurality of nested and foldable frame windows includes a plurality of ratio indicators each corresponding to one of a plurality of corresponding artwork substrate sizes for the viewfinder opening.

In embodiments of this invention, each of the plurality of nested and foldable frame windows includes a plurality of tick marks corresponding to a respective frame window, for assisting with aligning subject within the opening. The plurality of tick marks are desirably disposed at golden ratio positions for a corresponding viewfinder opening of the respective frame window. In embodiments, each of the plurality of nested and foldable frame windows includes eight tick marks, with two tick marks on each side. Other combinations, such as crosshair orientations are also available.

In embodiments of this invention, each of the plurality of nested and foldable frame windows includes a foldable hinge, desirably disposed on sides of the frame windows that are disposed toward a same outer edge of the viewfinder device. The hinge can be a material bridge, scored or perforated line, or other hinge structure. In embodiments, each of the plurality of nested and foldable frame windows comprises cuts through a device substrate on three sides, and a foldable hinge on a fourth side.

The invention further includes a viewfinder device of a device substrate and including an outer frame window having four outer frame sides forming an outer frame perimeter. The outer frame perimeter includes cuts through the device substrate on three outer frame sides of the outer frame perimeter. The device also includes a first nested frame window having four first nested frame sides forming a first nested frame perimeter that is within the outer frame perimeter. The first nested frame perimeter includes cuts through the device substrate on three sides of the first nested frame perimeter. The device further includes a second nested frame window having four second nested frame sides forming a second nested frame perimeter that is within the first nested frame perimeter. The second nested frame perimeter including cuts through the device substrate on three sides of the second nested frame perimeter. Additional frame windows can be nested within the second nested frame window.

The device substrate has a substrate edge, and desirably each of the outer frame window, the first nested frame window, and the second nested frame window includes a foldable hinge on a fourth frame side disposed toward the substrate edge.

In embodiments, a plurality of tick marks are outside and adjacent to each side of: the outer frame perimeter, the first nested frame perimeter, and the second nested frame perimeter. Each of the outer frame window, the first nested frame window, and the second nested frame window is foldable to open a corresponding viewfinder opening, and the plurality of tick marks are desirably disposed at golden ratio positions for the corresponding viewfinder opening.

Each of the outer frame window, the first nested frame window, and the second nested frame window is foldable to open a corresponding viewfinder opening. Each also desirably includes a plurality of ratio indicators each corresponding to one of a plurality of painting substrate sizes for the corresponding viewfinder opening.

In embodiments, the device substrate comprises an outer frame surrounding the outer frame window. The outer frame can include composition type guidelines, grounded value motifs, and/or story check prompts to further assist the user.

The invention further includes a method of use. In embodiments, the user folds one of the nested frame windows to open a viewfinder opening corresponding to a size of a substrate to be painted or drawn and through which a subject of an artwork is to be viewed.

### BRIEF DESCRIPTION OF THE DRAWINGS

FIG. 1 shows a front view of a viewfinder according to embodiments of this invention.

FIG. 2 shows a back view of the viewfinder of FIG. 1.

FIG. 3 shows a front view of a viewfinder according to embodiments of this invention.

FIGS. 4 and 5 each show a viewfinder with frames opened, according to embodiments of this invention.

FIGS. 6-8 each show an operation of a viewfinder according to embodiments of this invention.

### DETAILED DESCRIPTION OF THE INVENTION

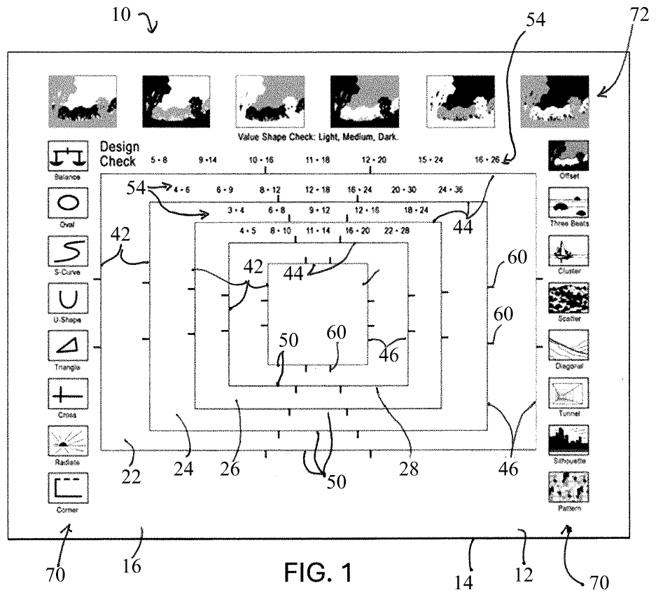

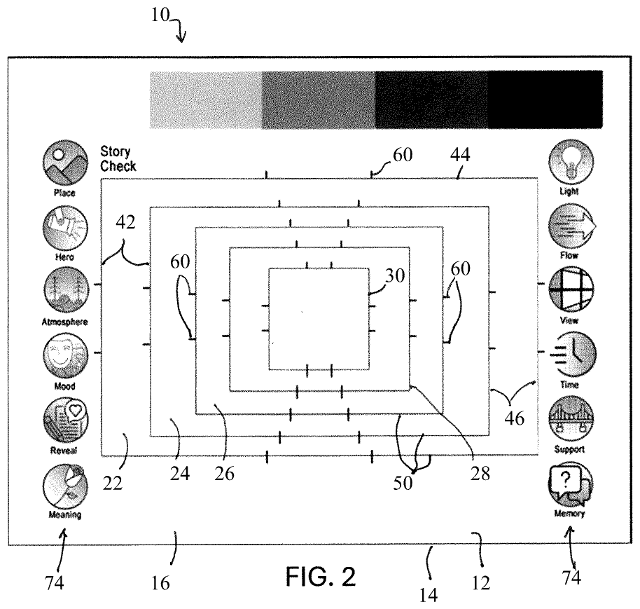

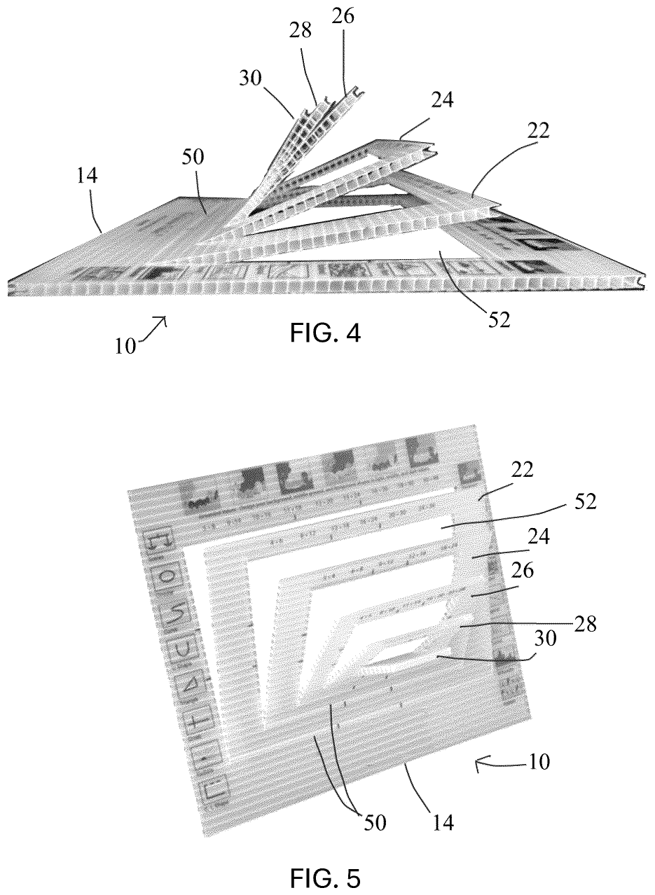

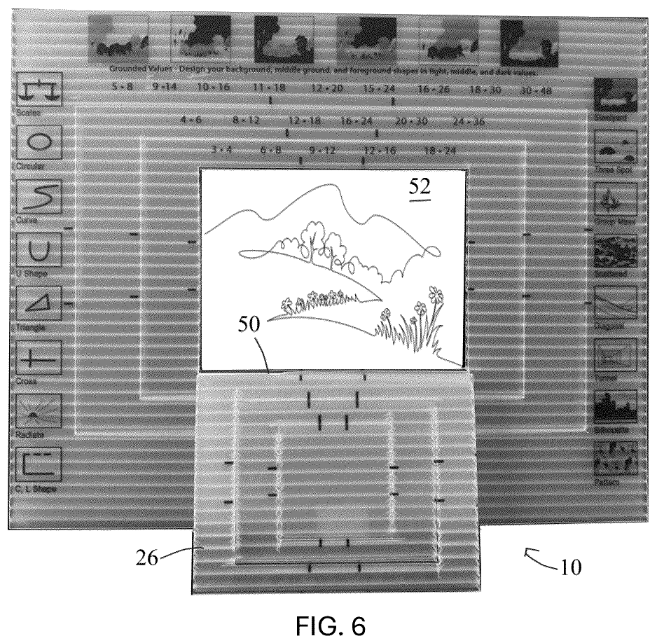

The invention provides a viewfinder that can be used by artists to frame their intended subject, such as a landscape or a person. Referring to FIGS. 1 and 2, the device 10 includes a planar substrate 12, which includes a plurality of nested shapes or frame windows 22, 24, 26, 28, and 30, each cut along three sides 42, 44, and 46 of a frame periphery 40 within the substrate 12 and including a hinge 50 at the fourth side 48, all disposed toward substrate bottom edge 14. As shown in FIGS. 4 and 5, each of the nested window frames 22, 24, 26, 28, and 30 can be independently and separately folded downward to provide a corresponding viewfinder window opening 52. The viewfinder window opening 52 is then used to determine the desired composition for the artwork, as shown in FIG. 6 (framing a landscape to be painted or drawn).

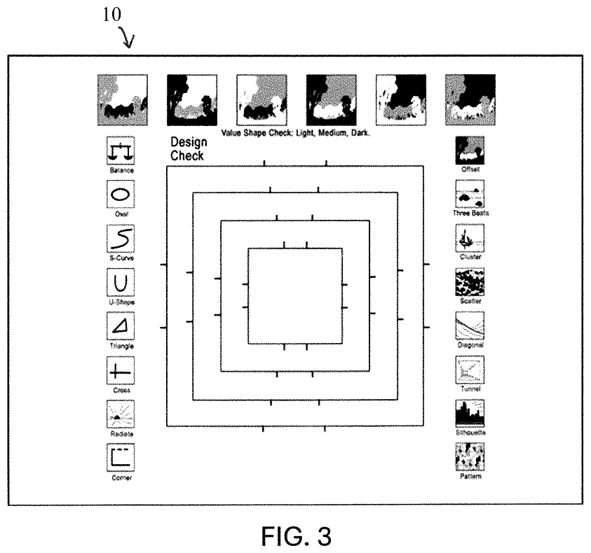

Each nested frame window 22, 24, 26, 28, and 30 has a different aspect ratio that corresponds to common art substrate (e.g., canvas) sizes. Each nested frame window 22, 24, 26, 28, and 30 is associated with ratio indicators 54 adjacent the corresponding frame window to inform the user which frame window to use for a particular canvas size. As illustrated, the nested frame windows 22, 24, 26, 28, and 30 are mostly rectangular with the smallest window being square. The size and shape of the cut frames can vary, depending on need. In alternative embodiments more than one or all of the frame windows are nested squares as shown in FIG. 3. Other shapes can be used as well.

In embodiments, the device is formed of a corrugated plastic substrate, such as having three layers of polymer substrate. Two external layers of plastic sheeting hold together an internal layer of channel-like plastic (see FIG. 4). Each frame/window is designed with a cut top and sides and only partially cut on the back at the bottom, creating a natural hinge at the front layer. This allows the windows to fold down neatly and serve as a customizable viewfinder for various standard panel sizes artists use.

The device is made of any suitable durable material ideally suited for the continuous operation of the windows, ensuring a crisp fold and a smooth experience when adjusting or closing views. Above each frame window 22, 24, 26, 28, and 30, the ratio indicators 54 are marked out as a guide to standard panel sizes, making it easier for the user to envision the subject on different scales. This feature is especially valuable for artists across various substrates and sizes.

In preferred embodiments, the device includes tick marks 60, desirably printed, that are placed at the golden ratios for each of the frame window 22, 24, 26, 28, and 30, giving the user easy reference points. Connecting these marks within the compositions gives the user good locations to place areas of focus. These divisions help align the center of interest, creating a dynamic and engaging design. As used herein. the golden ratio is a mathematical concept that can enhance the visual appeal of a work by guiding the placement of key elements. The golden ratio, also known as the golden number, golden proportion, or the divine proportion, is a ratio between two numbers that equals approximately 1.618. Usually written as the Greek letter phi. As illustrated, each frame window 22, 24, 26, 28, and 30 has eight tick marks 60, two on each side, and opposing tick marks are aligned on opposing sides.

In embodiments, the outer frame 16 has on opposing sides different composition type guidelines 70 providing information for a good design starting point. The illustrated device has a total of sixteen composition types, with eight on each side, which are inspired by the composition principles of Edgar Payne. The user can rotate the device 10 to view the possible compositions. The sixteen ideas are merely suggestions, and can provide reminders for diverse approaches to structure the scene. Additionally, there is space available along the bottom of the device for the user to add additional unique compositional types. In the illustrated embodiments, the composition type guidelines include:
1. “Balance,” refers to even balance from left to right, like a scale;
2. “Oval,” refers to a looping design that brings the eye around and back;
3. “S-Curve,” refers to a flowing path that carries the eye through the scene with rhythm;
4. “U-Shape,” refers to a “cradle” that frames a center space and keeps the eye contained;
5. “Triangle,” refers to a strong, stable structure that naturally points attention and creates order;
6. “Cross,” refers to a vertical and horizontal structure that creates a clear anchor and strong center pull;
7. “Radiating,” refers to lines or shapes that spread outward (or converge inward) to create energy and direction;
8. “Corner,” refers to a C or L structure that wraps the scene and holds the action in place;
9. “Offset,” refers to a larger mass balanced by a smaller counterweight (uneven, lively, and very common in strong landscapes);
10. “Three Beats,” refers to three main points of interest that lead the eye in a deliberate sequence;
11. “Cluster,” refers to many smaller elements grouped into a few big readable masses;
12. “Scatter,” refers to elements spread across the frame with no single dominant mass. Works best when you control rhythm and repetition;
13. “Diagonal,” refers to a slanted structure that creates movement, tension, and momentum;
14. “Tunnel,” refers to a depth “funnel” that pulls the eye inward using perspective and overlap.
15. “Silhouette,” refers to big, readable shapes defined by strong value contrast and clear edges; and
16. “Pattern,” refers to repeating motifs that create rhythm, unity, and visual music.

As illustrated at the top of the outer frame 16, the device has six “grounded value” motifs 72 to assist the user with composition design. These motifs 72 assist the user to divide the scene into three parts: Foreground, Middle Ground, and Background shapes, and assign them a light, medium, or dark value. The illustrated graphics are a Steelyard composition type. The key is to focus on the contrasts created by these values. Combined creatively, paying attention to the power contrast has within these value relationships can significantly enhance a scene's dynamics, focus, and depth.

As shown in FIG. 2, the back of the device 10 includes story check prompts 74. These are provided to remind the user to make meaningful choices in determining and framing the subject using the device 10. In embodiments, the device 10 is used according to the following steps: 1) pick a window that matches the art panel; 2) look through the open window and choose a composition; 3) use the tick marks to place a focal area; 4) squint and do a quick three-value check-light, medium, dark; and 5) do a story check by flipping the device over and connect with a story.

As shown in FIG. 6, during use, the user selects the appropriate window. The user opens the window that matches the user's panel or paper size, by pulling the window flap towards the user. Each window has a set of numbers along the top that represents the proportional size of that window. So, for example, if the user is painting on a 12″×16″ panel, then the window that has 12·16 written above it is used. Once the user is done, the folded portion snaps back into place.

Adjusting the distance between the device and the user's eye can be used to explore various compositions. By doing so, the user can modify the extent of the view, enabling the user to capture broader or narrower perspectives. The device allows for experimenting with different distances to observe how it changes the scene and which elements come into focus.

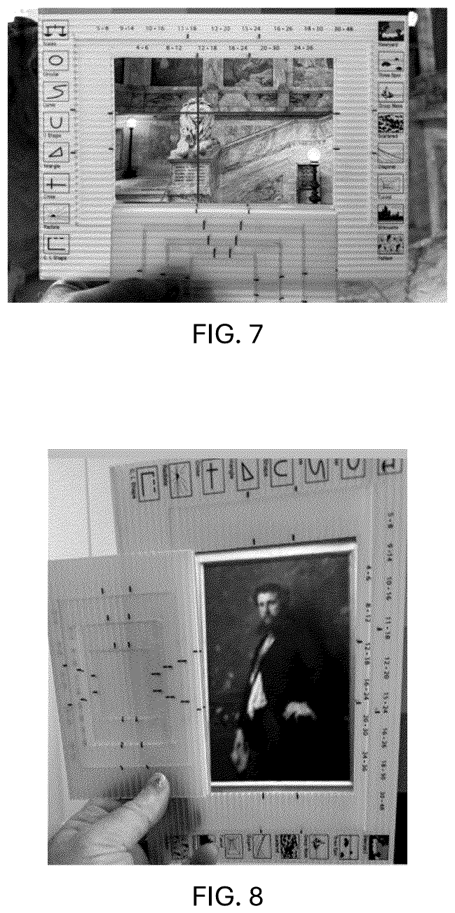

The illustrated device has five windows, each having eight tick marks corresponding to the golden ratio for that particular opening. The user can choose top or bottom and left or right tick marks as guides to place the area of interest. The intersection of these parallel marks indicates the ‘sweet spots’ within the composition. While looking through the window, the user positions the center of interest near the imaginary cross that connects opposite tick marks, such as shown in FIG. 7. This technique helps to create a balanced and aesthetically pleasing composition.

After choosing the scene and composition using the device, the next step is to transfer the layout onto the panel or paper. To do this, the user holds the device up to the panel and aligns the device with the edges. Then, by referring back and forth from the scene to the panel, the user can draw in the major shapes. This helps to ensure that the shapes and proportions of the chosen scene are accurately translated onto the work surface.

To create an accurate sketch of a scene, the user should first observe the significant shapes and elements within the relevant window. Then, the user sketches these shapes onto the panel while mirroring their positions and sizes as seen through the device. The user can also mark the golden ratio tick marks on the board or paper. While looking through the device, lightly mark where these tick marks align with critical elements of the scene. This will help achieve a balanced and visually pleasing composition.

The device is also useful for examining existing artwork. The user can use the device to study the placement of the Center of Interest, and try to identify which composition type may have been used. This additional knowledge can help the user make better design decisions when creating paintings. FIG. 8 shows the device being used at the Museum of Fine Arts in Boston to study a work by John Singer Sargent's. Here, the artist used the three-point composition type, with the right hand aligned on the golden ratio line.

Thus the invention provides a useful artistic tool for establishing or learning an intended framing composition for a subject. As will be appreciated various sizes, shapes, amounts, and configurations are available for the device, the frame windows, the tick marks.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. A viewfinder device comprising a plurality of nested and foldable frame windows.

2. The device of claim 1, wherein each of the plurality of nested and foldable frame windows is foldable to open a corresponding viewfinder opening.

3. The device of claim 2, wherein the each of the plurality of nested and foldable frame windows corresponds to a predetermined painting substrate size.

4. The device of claim 2, wherein each of the plurality of nested and foldable frame windows includes a plurality of ratio indicators each corresponding to one of a plurality of corresponding painting substrate sizes for the viewfinder opening.

5. The device of claim 1, wherein each of the plurality of nested and foldable frame windows includes a plurality of tick marks corresponding to a respective frame window.

6. The device of claim 5, wherein the plurality of tick marks are disposed at golden ratio positions for a corresponding viewfinder opening of the respective frame window.

7. The device of claim 5, wherein each of the plurality of nested and foldable frame windows includes eight tick marks, with two tick marks on each side.

8. The device of claim 1, wherein each of the plurality of nested and foldable frame windows includes a foldable hinge, and the foldable hinge is disposed on a side of a corresponding frame window that is disposed toward a same outer edge of the viewfinder device.

9. The device of claim 1, wherein each of the plurality of nested and foldable frame windows includes a foldable hinge and a plurality of ratio indicators corresponding to the respective frame window.

10. The device of claim 1, further comprising a device substrate and wherein each of the plurality of nested and foldable frame windows comprises cuts through the device substrate on three sides, and a foldable hinge on a fourth side.

11. The device of claim 1, further comprising a device substrate and wherein the plurality of nested and foldable frame windows comprises:
an outer frame window having four outer frame sides forming an outer frame perimeter, the outer frame window defined by cuts through the device substrate on three outer frame sides of the outer frame perimeter;
a first nested frame window having four first nested frame sides forming a first nested frame perimeter that is within the outer frame perimeter, the first nested frame window defined by cuts through the device substrate on three sides of the first nested frame perimeter; and
a second nested frame window having four second nested frame sides forming a second nested frame perimeter that is within the first nested frame perimeter, the second nested frame window defined by cuts through the device substrate on three sides of the second nested frame perimeter.

12. The device of claim 11, wherein each of the plurality of frame windows includes a foldable hinge on a fourth frame side.

13. A method of using the device of claim 1, by folding one of the nested frame windows to open a viewfinder opening corresponding to a size of a substrate to be painted or drawn and through which a subject of an artwork is to be viewed.

14. A viewfinder device, comprising:
a device substrate;
an outer frame window having four outer frame sides forming an outer frame perimeter, the outer frame perimeter including cuts through the device substrate on three outer frame sides of the outer frame perimeter;
a first nested frame window having four first nested frame sides forming a first nested frame perimeter that is within the outer frame perimeter, the first nested frame perimeter including cuts through the device substrate on three sides of the first nested frame perimeter; and
a second nested frame window having four second nested frame sides forming a second nested frame perimeter that is within the first nested frame perimeter, the second nested frame perimeter including cuts through the device substrate on three sides of the second nested frame perimeter.

15. The device of claim 14, further comprising a third nested frame window having four third nested frame sides forming a third nested frame perimeter that is within the second nested frame perimeter, the third nested frame perimeter including cuts through in the device substrate on three sides of the third nested frame perimeter.

16. The device of claim 14, wherein the device substrate comprises a substrate edge, and each of the outer frame window, the first nested frame window, and the second nested frame window includes a foldable hinge on a fourth frame side disposed toward the substrate edge.

17. The device of claim 14, further comprising a plurality of tick marks outside and adjacent to each side of: the outer frame perimeter, the first nested frame perimeter, and the second nested frame perimeter.

18. The device of claim 17, wherein each of the outer frame window, the first nested frame window, and the second nested frame window is foldable to open a corresponding viewfinder opening, and the plurality of tick marks are disposed at golden ratio positions for the corresponding viewfinder opening.

19. The device of claim 14, wherein each of the outer frame window, the first nested frame window, and the second nested frame window: is foldable to open a corresponding viewfinder opening; and comprises a plurality of ratio indicators each corresponding to one of a plurality of painting substrate sizes for the corresponding viewfinder opening.

20. The device of claim 14, wherein the device substrate comprises:
an outer frame surrounding the outer frame window; and
composition type guidelines disposed on the outer frame.
